(19) United States
(12) Patent Application Publication
(10) Pub. No.: US 2005/0010689 A1
(43) Pub. Date: Jan. 13, 2005

(54) Methods and device for interfacing communication between devices on different networks

(76) Inventors: Jean-Baptiste Henry, Melesse (FR); Thomas Brune, Hannover (DE)

Correspondence Address: Joseph S Tripoli;Thomson Licensing Inc, Patent Department, PO Box 5312, Princeton, NJ, 08543-5312, US

(21) Appl. No.: 10/487,469

(22) PCT Filed: Aug. 22, 2002
(86) PCT No.: PCT/EP02/09478

(30) Foreign Application Priority Data
Aug. 22, 2001 (EP) 01402207.3

(51) Int. Cl. G06F 15/16

(52) U.S. Cl. 709/246

(57) ABSTRACT

The invention concerns a 1. Method for interfacing communication between a first device on a first network and a second device on a second network, the networks being connected by an interface device, the method being carried out by the interface device and being characterized by the steps of: detecting a first message on the first network, said first message being generated by the first device, said first message being relevant for the second device; translating the first message into a format compatible with the second device; sending a second message to the second device on the second network, the second message informing the second device that the first message has been detected; upon reception of a request from the second device, transmitting the translated first message. The invention also concerns a device for implementing the method.

The invention concerns methods for communication between devices on different networks, in particular for transmitting notifications from one network to the other, as well as a device for implementing the methods. The invention can be applied for example to a HAVi network connected to an IP based network.

Be it in the areas of television, home networking or the Internet, new communication technologies are being developed and introduced at a fast pace. Each environment boasts different protocols, stacks and graphical interfaces.

There appears the need of rendering these different environments interoperable. The HAVi specification focuses on the interoperability of consumer electronics devices in the home environment. It may prove useful to be able to control HAVi devices through means external to the HAVi domain sub-network, and in particular through an Internet-enabled device, which would access the HAVi sub-network through the Internet. Conversely, the control of a device connected to the Internet using a HAVi device should also be possible.

Looking at the user interfaces in each area, HAVi currently proposes three different mechanisms. One of the mechanisms, called Device Driven Interaction, or ‘DDI’, allows a device (called the DDI target) to display its user interface through another device (called the DDI controller).

In IP-based networks, HTML is widely used for rendering graphics, eventually supplemented by scripts such as javascript or different plug-ins, e.g. Java applets.

One aspect of the interconnection between a HAVi sub-network (domain) and an IP-based network is the notification of events through the interconnecting device, as well as that of actions triggered in one network, but addressed to devices in the other network.

More specifically, the invention concerns a method for interfacing communication between a first device on a first network and a second device on a second network, the networks being connected by an interface device, the method being carried out by the interface device and being characterized by the steps of:
detecting a first message on the first network, said first message being generated by the first device, said first message being relevant for the second device;
translating the first message into a format compatible with the second device;
sending a second message to the second device on the second network, the second message informing the second device that the first message has been detected;
upon reception of a request from the second device, transmitting the translated first message.

According to an embodiment of the invention, the interface device further carries out the steps of
providing at least one applet, wherein said applet is adapted to receive the second message and to generate the request; and
transmitting the applet to the second device.

According to an embodiment of the invention, the method further comprises the step of
including the at least one applet into at least one html page, and transmitting the at least one page to the second device.

According to an embodiment of the invention, the step of translating the first message comprises the steps of updating at least one relevant object of the html page with parameters contained in the first message.

According to an embodiment of the invention, the method further comprises the step of:
retrieving user interface elements of the first device;
translating the user interface elements into a format compatible for control of the first device through the second device;
including the translated user interface elements into the html page.

According to an embodiment of the invention, the step of translating the first message comprises updating at least one translated user interface element, based on parameters comprised in the first message.

According to an embodiment of the invention, the html page comprises at least one java object and/or at least one html object.

According to an embodiment of the invention, the step of sending the second message to the second device comprises performing a remote method invocation call to the applet, the remote method of the applet being such as to trigger an appropriate request from the second device to the interface device for transmission of the translated first message.

According to an embodiment of the invention, the request comprises one of the following: an HTML GET message, a remote method invocation call to the interface device.

According to an embodiment of the invention, the applet is adapted to regularly poll a predetermined port of the interface device for determining whether a translated message is available at the interface device.

According to an embodiment of the invention, the request for transmission of the translated first message comprises one of the following:
a request to transmit an update of part of an html page; or
a request to transmit an update of an entire html page; or
a request to transmit an update of a java object or an HTML object.

According to an embodiment of the invention, the first network is a HAVi network.

According to an embodiment of the invention, the second network is an Internet Protocol based network.

According to an embodiment of the invention, the first network is an Internet Protocol based network and the step of receiving the first message comprises receiving said message on a predetermined port from an applet in the first device.

According to an embodiment of the invention, the first network is an Internet Protocol based network and the step of receiving the first message comprises receiving said message through a remote method invocation call performed by an applet in the first device.

Another object of the invention is a device for interfacing communication between a first device on a first network and a second device on a second network, said device comprising
means for detecting a first message on the first network, said first message being generated by the first device, said first message being relevant for the second device;
means for translating the first message into a format compatible with the second device;
means for sending a second message to the second device on the second network, the second message informing the second device that the first message has been detected and upon reception of a request from the second device, transmitting the translated first message.

According to an embodiment of the invention, the device further comprises memory for storing user interface element representations for user interface elements of devices of the first network for control by devices of the second network and vice-versa, and means for translating the user interface elements of the first device according to the representations, for transmission of the translated elements to the second device, wherein the translation means are adapted to translating actions performed on one device or notifications generated by one device to a format compatible with the other device.

Another object of the invention is a method for interfacing communication between a first device on a first network and a second device on a second network, the networks being connected by an interface device, the method being carried out by the interface device and being characterized by the steps of:
detecting a first message on the first network, said first message being generated by the first device, said first message being relevant for the second device;
translating the first message into a format compatible with the second device;
transmitting the translated message to the second device,
wherein the first and second networks are IP and HAVi networks or vice-versa, and wherein the message is a notification or an action.

According to an embodiment of the invention, the exchange of a notification or action between the interface device and a device on an IP based network is carried out through a remote method invocation call.

According to an embodiment of the invention, the transmission of a notification from the interface device to the second device on an IP based network includes having the second device regularly poll a fixed port of the interface device acting as a server.

Other characteristics and advantages of the invention will appear through the description of a non-restrictive embodiment, explained with the help of the enclosed drawings.

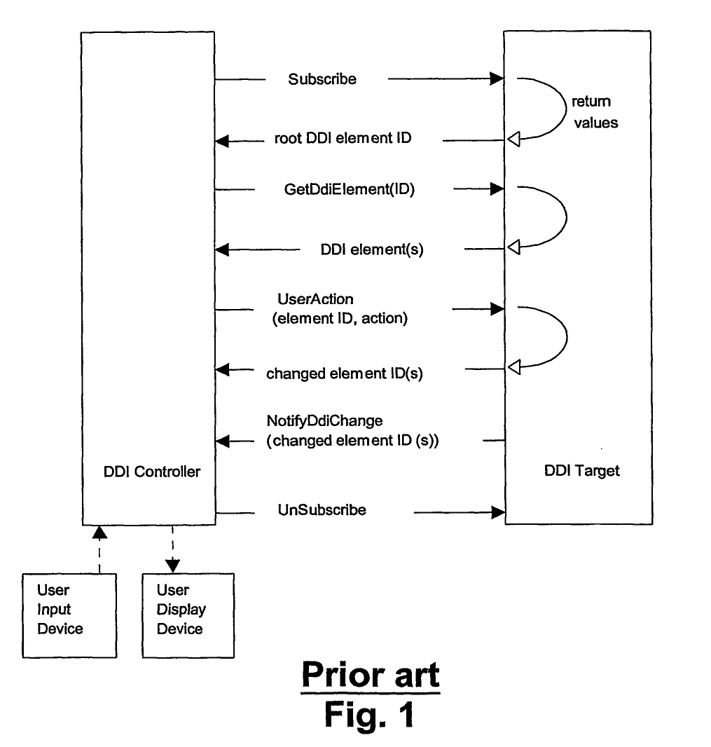

FIG. 1 is a prior art diagram of the information exchanges between a DDI controller and a DDI target.

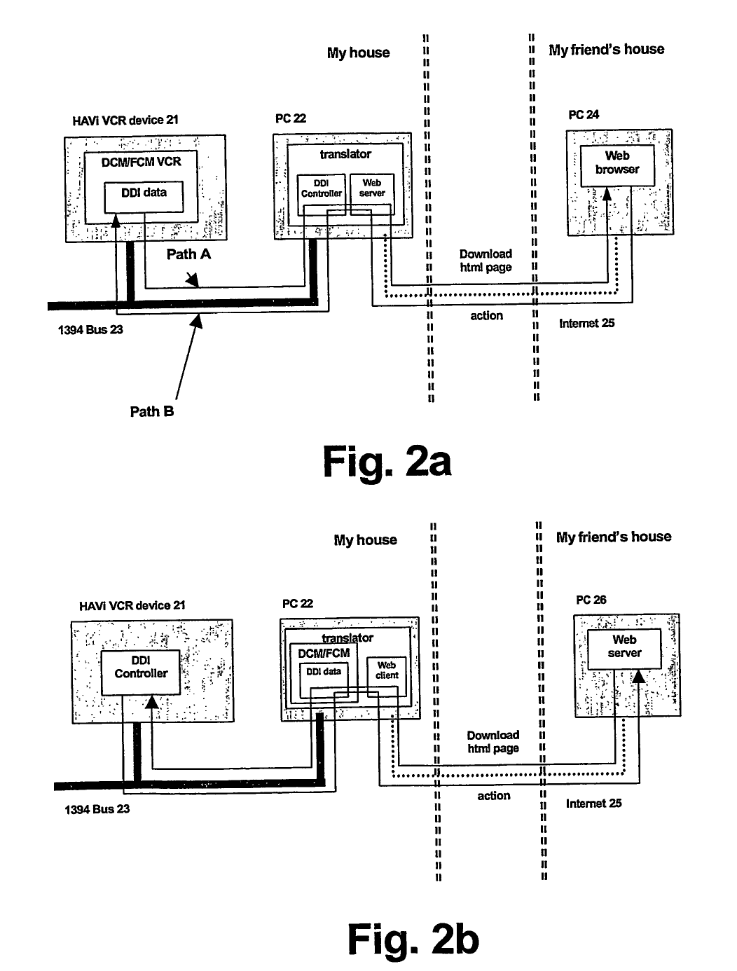

FIG. 2a is a block diagram of a network comprising a HAVi domain and an Internet domain, in case a web user accesses a HAVi target.

FIG. 2b represents the domain (sub-network) of FIG. 2 when a HAVi user accesses a web target.

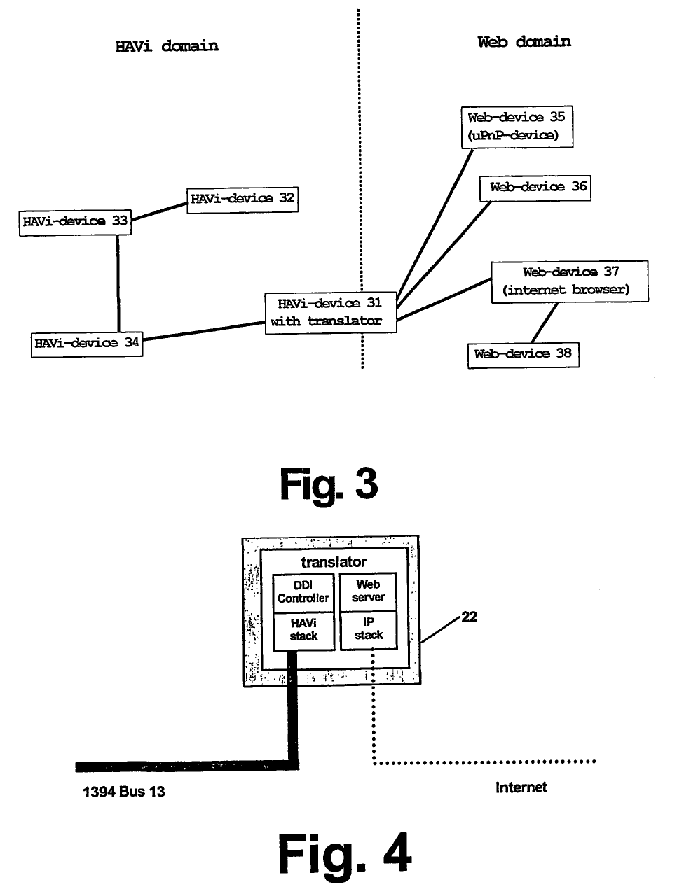

FIG. 3 is a block diagram of another network formed by the interconnection of a HAVi domain and of an Internet domain.

FIG. 4 is a diagram of the software architecture of a device of FIG. 3 comprising the translator application according to the present embodiment.

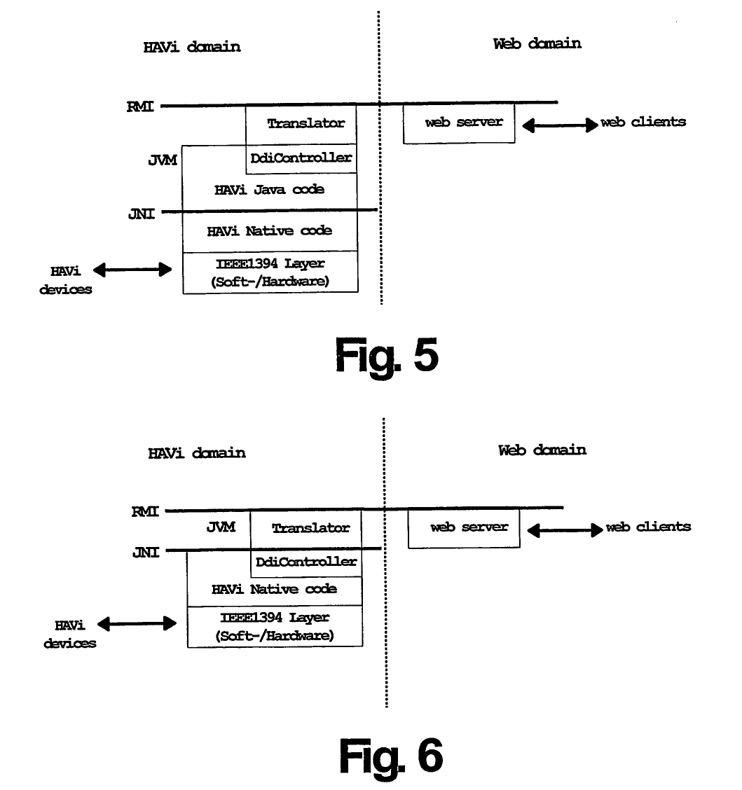

FIG. 5 is a diagram of a first implementation of the software stack in the device of FIG. 3 using Remote Method Invocation (RMI), and in the case a DDI controller of the device is based on Java.

FIG. 6 is a diagram of a second implementation of the software stack in the device of FIG. 3 using RMI, and in the case a DDI controller of the device is a native controller.

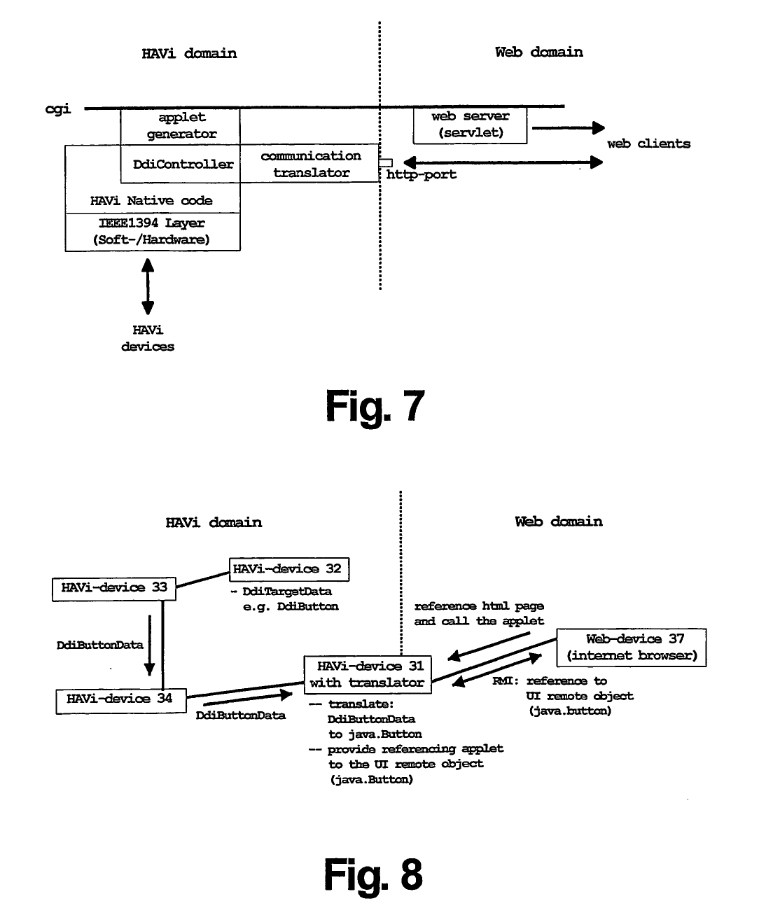

FIG. 7 is a diagram of a third implementation of the software stack in the device of FIG. 3, when a cgi API is used.

FIG. 8 is diagram illustrating the steps for setting up a user interface provided by a HAVi device on an Internet device, according to the present embodiment of the invention.

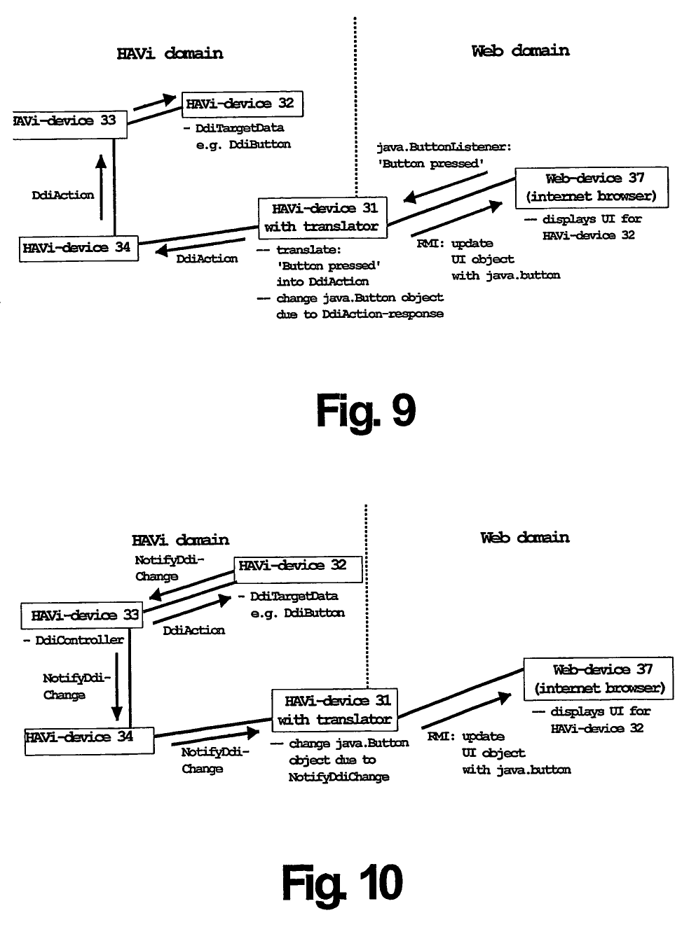

FIG. 9 is a diagram illustrating of the steps carried out when an action is initiated from the Internet domain, according to the present embodiment of the invention.

FIG. 10 is a diagram illustrating the steps carried out for spreading a notification from the HAVi domain to the Internet domain, according to the present embodiment.

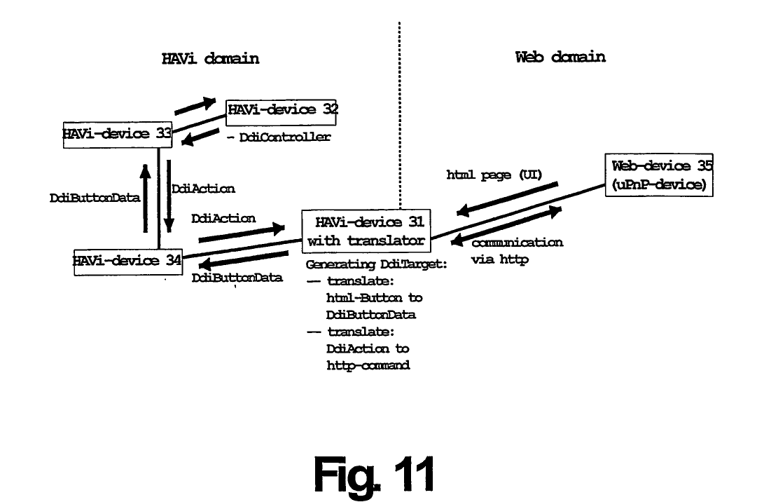

FIG. 11 is a diagram illustrating the steps for setting up a user interface provided by an Internet device on a HAVi device, according to the present embodiment.

The embodiment of the invention is based on one side on the HAVi specification (Home Audio/Video interoperability), and on the other side on Internet related technologies, such as IP (Internet Protocol), UPnP (Universal Plug and Play), HTML (HyperText Markup Language) and HTTP (Hypertext Transfer Protocol).

References of the versions at the priority date of the present application are as follows:
The HAVi 1.1 specification (published May 15, 2001) is available from HAVi Inc., 2694 Bishop Drive, Suite 275 San Ramon, Calif. 94583, USA.
The UPnP 1.0 specification is available from Microsoft Corp.
The HTML 4.01 document is available from the W3C consortium (MIT in the USA, INRIA in France and Keio University in Japan).
The HTTP Protocol is available from the IETF (Internet Engineering Task Force). The most current version is HTTP 1.1, as described in RFC 2616.
HTTP (Hypertext Transfer Protocol) is an application level protocol for distributed, collaborative hypermedia information systems. It is a generic, stateless protocol.

The present embodiment mainly focuses on interfacing a HAVi network with a remote device through the Internet. The remote device is typically a personal computer with a standard web browser. Of course, the Man Skilled in the Art will readily adapt certain aspects described in the context of the embodiment to other environments.

HAVi defines a number of system elements (CMM1394, Messaging System, Registry, Event Manager, Stream Manager, Resource Manager and DCM Manager). They provide a way to manage the HAVi network over an IEEE 1394 serial bus. HAVi further defines the following elements:
The DCMs: Device Control Modules are the software representation of a controlled device on the network. There is one DCM per device.
The FCMs: Functional Control Modules are the software representation of a functionality on the network. A FCM is contained in a DCM (the functionality is provided by a device), and a DCM can contain several FCMs (e.g. a D-VHS can provide a Tuner functionality and a VCR functionality).
The applications: a software element that generally provides a user interface and allows control of devices and of the network.
The Havlets: a Havlet (HAVi applet) is a Java bytecode contained in a DCM (or elsewhere), which can be downloaded to a controller running a Virtual Machine (such a controller is called a FAV type device—Full Audio/Video device), in order to provide a user interface related to the DCM. This mechanism allows the manufacturer of the DCM to distribute its own look and feel across the network.
A DDI Controller Its aim is to display the DDI data provided by a DDI Target (i.e. a DCM).

HAVi Defines Three User Interface Mechanisms to Control the Network:

1. Native User Interface:

The native user interface is the user interface provided directly by the controller device to the user in a proprietary way. The user interface may be based on Java, Visual Basic, Windows, Linux, etc. For example, the navigator of the Home Network configuration (i.e. the initial user interface entry point to user interfaces of all other devices of the HAVi network) must be a native user interface. In addition, the user interface for one specific device within the network can also be native (e.g. for controlling a standardized FCM). For example, to control a VCR (a VCR API is defined by HAVi), the native user interface can display the VCR buttons, the current time and other parameters and controls.

2. DDI User Interface:

DDI stands for Data Driven Interaction. A HAVI software element may provide a user with the ability to control another software element using the HAVi DDI mechanism. The first software element is called the DDI Controller and the second software element the DDI Target. The DDI Target is in fact the controlled DCM (or application module). The DDI Target provides “DDI data”, which is a description of a user interface to be presented to the user. This DDI data indicates the state of the DDI Target and defines how the DDI Controller may send commands.

Furthermore, DDI is a scalable process. With the same DDI data, while a very simple display (a mobile phone for example) will show only some text buttons, a more powerful device (like a PC) can show picture buttons. This is possible because the DDI data provides at least basic information (e.g. button labels) and optionally more complex information (e.g. pictures). The DDI Controller decides how to display DDI data on its screen.

The DDI Controller has no knowledge of functionalities of the DDI Target. It transmits messages (e.g. ‘DdiAction’) to the DDI Target in response to user commands. On the Target side, the DDI Target translates the coded DdiAction into a device function. For example, the DDI Controller sends a DdiAction of the type “button 5 pressed” to a VCR DDI Target, and the DDI target translates it into a command such as “Play”.

FIG. 1, prior art, illustrates the different exchanges between a DDI Controller and a DDI Target.

3. Havlet:

The Havlet is a part of a DCM (or application module), a Java bytecode that can be downloaded to any controller running a Virtual Machine. This bytecode provides the user interface of the DCM. Through this, the manufacturer of the DCM can impose its own look and feel.

When a controller installs a Havlet, its own application does not know anything about what the Havlet does, which commands it sends etc . . . . The Havlet has the complete responsibility for the graphical control and message exchange with the target device.

For controlling the multimedia home domain from the web (or vice-versa) and for displaying information from the home domain on a web device (or vice-versa), a graphical translator between the DDI mechanism and the Internet technologies (HTML, HTTP, Java enhancements . . . ) is implemented. The translator works in both directions:
(a) It translates HAVi DDI graphics into graphics usable by a device of the other network (i.e. HTML graphics in the present embodiment), which displays them on an appropriate user interface. The HTML data are accessible through a page, proposed by the web server part of the translator device 22. This page is downloaded by the web browser for rendering. The actions of a user on the HTML graphics are translated back into HAVi commands (i.e. DDI user actions) on the HAVi network. This allows for example a device connected to the Internet and comprising a web browser to control a HAVi device through the elements represented on the user interface.
(b) It translates a user interface of the IP-based network into DDI data. This allows a controller device of the Home Network, which is not connected directly to the Internet, to access the device through the generated DDI elements. In particular, it allows translation of certain UPnP graphics (based on HTML) into HAVi graphics. A HAVi device can then easily control a UPnP device and vice-versa.

The translator has the function of translating or converting the graphical part of the user interface and the function of translating the actions (commands) and notifications of the user interface.

More specifically, the command and control translation comprises:
Translation of the home network action (‘DDiAction’) mechanism to the IP domain, so that the user may control a HAVi device from a web page;
Translation of the home network notification (‘NotifyDDiChange’) mechanism to the IP domain, so that the user may see the HAVi device's status change on his translated user interface in the IP domain (an alternative to the ‘NotifyDDiChange’ are the ‘StateChanged’-events of several DCMs which consist in a deeper layer notification mechanism within the HAVi stack);
Translation of an action mechanism from web pages to the HAVi domain, so that the user may control web pages with ‘DdiAction’ commands;
Translation of a notification mechanism within the web to the HAVi domain, so that the user may see changes on web pages in his translated user interface in the HAVi domain.

According to the present embodiment, the terms ‘web page’ designate an HTML-based page (to be rendered on a web browser), which can be enhanced with scripts or java applets to allow the user to generate actions when interacting with the page elements (e.g. buttons).

FIG. 2a is a block diagram of a two-domain network, in which the first domain is of the HAVi type and the second domain is of the Internet Protocol (IP) type. The HAVi domain comprises a HAVi VCR device 21 and a personal computer 22, both devices being connected to an IEEE 1394 bus 23. The device 21 comprises a VCR DCM and FCM. The device 22 comprises the translator according to the present embodiment, and is also connected to the Internet 25, to which a device—here a personal computer 24—comprising a Web browser is connected. The translator comprises a DDI Controller and a web server part.

A typical user control process will now be described, in order to illustrate the translator's role in a real environment.

A user desires to access the VCR 21 from his friend's home, in order to record a movie he has just heard about. He accesses his home HAVI network using the web browser of the device 24. The device 22 acts as a web server in this case, and has an IP-address known to the user. The device 22 requests the DDI data (Path A) from the VCR 21, translates it into web page format and sends it on request to the remote computer 24, which displays it on its browser.

The user has then access to VCR controls presented by the browser on the web page created by device 22. He can also see the status of the VCR. The user activates the ‘Record’ button. A corresponding message (Path B) is sent to the web server part of the translator. The translator converts the message into a DDI user action. This user action is sent to the DDI Target of the VCR device 21, which acts accordingly.

FIG. 2b is similar to FIG. 2a, but illustrates the case where a device on the IP domain (in this case a web server located on a computer 24) is controlled through the HAVi VCR 22 (connected to a display such as a television monitor, which is not illustrated). The latter possesses a HAVi DDI controller, which accesses DDI data provided by the translator of device 22, based on elements of the user interface (e.g. HTML) pages obtained from web server 24. The translator presents on the HAVi network a proxy DCM and FCM corresponding to the device 24, in order to be compatible with the DDI procedure described in the HAVi specification. On the Internet side, the device 22 presents a web client. Device 26 is then considered to be the web server.

In both cases, it is supposed that the device 22 is aware of the devices connected to each domain, using known techniques for each domain (e.g. the registry for the HAVi domain, and the appropriate protocols such as GENA and SSDP for UPnP devices in the IP domain).

FIG. 3 is a block diagram of another two-domain network comprising a HAVi domain and an Internet domain. In the case of this network, the HAVi domain comprises devices 31 to 34, where device 31 is the HAVi device incorporating the translator. The Internet domain comprises, as example, four Internet devices 35 to 38, where device 35 is UPnP compliant and device 37 hosts an Internet browser.

FIG. 4 illustrates a simplified software architecture of the HAVi device 31: the translator application sits atop the HAVi stack and the DDI Controller on the HAVi side and atop the Internet Protocol (IP) stack and the web server layer on the other side.

The translator is a piece of software used in conjunction with the DDIController. It is present on a HAVi device that also comprises a DDIController. Due to the fact that the aim in the present embodiment is to operate with Internet devices, a web server is provided within the same HAVi device 31. The communication path runs from a web client—for example the device 37 incorporating the browser—to the web server and, via an appropriate Application Programmable Interface (API), to an application (e.g. the HAVi Software/Hardware Stack) and back. The web server and web client are considered as residing in the web domain and the application is—in the present embodiment—in the HAVi domain, in one of the devices 31 to 34.

There is the need for translating graphical objects, actions and notifications between the two domains, where:
1) Graphical objects are e.g. panels, text, buttons, . . .
2) Actions are messages generated for example by activating user interface elements. This may require a change of appearance of a graphical object such as a button, e.g. in order to reflect the action was activated. An action may also be generated by an application.
3) A notification is a message informing a device of an event on the network. This may cause a change of appearance of a graphical object, e.g. in order to reflect a new status of an object.

The problem is to send an action or notification message through the mentioned API from the web server and the application. A look at the server/client side of this problem shows:

1) While handling html-pages in the web domain, it is possible to have actions (e.g. by the user) on html-based objects and according re-actions (by the controlled device, through the translator).

On the other hand, there is no simple notification procedure available to the server to update the html pages displayed by the web client (device 37) on its own initiative (e.g. in FIG. 2a, the server of device 22 has no simple means for pushing data to the browser of device 24).

2) A simple solution is periodical polling: if there is a notification event in the HAVi domain, the application provides a new html-object (with a changed appearance). The client regularly (e.g. every few seconds) polls the server to obtain an HTML page containing the change. This may be achieved using a HTTP GET message. Note that the client PC 24 may also, through an appropriate applet running in a separate frame, obtain the header of the HTTP response, using a HTTP HEAD message, in order first to check whether the HTML page has been modified or not. The HTML page is requested only if there has indeed been a modification.

3) The present embodiment uses applets in addition to an API between the web domain and the HAVi domain:

Possible languages and/or scripts in the web domain are: JavaScript, Applets (this list not being exhaustive).

Possible solutions for the API between applications and the web server are: Java Remote Method Invocation (RMI), common gateway interface (cgi) and CORBA (again the list is not exhaustive).

In RMI, the HAVi application interacts with a Java Virtual Machine (JVM) and the Java Native Interface (JNI) has to be used to add the higher layer Java application to the lower layer native application. FIGS. 5 and 6 respectively show two software architecture models dependent on the DDIController implementation (either Java or native).

Another possibility for the API between the web server and the application relies on cgi (FIG. 7). Here, the user interface (an applet to be downloaded by the internet client) is provided via cgi. Communication is done via cgi (applet-/servlet-communication) as far as action handling is concerned (the client loads an applet from the server, for example the applet can be present in an html page, and the applet can send an ‘action’-triggered message back to the server), and via a predetermined http-port, as far as notification handling is concerned (the applet polls e.g. periodically every second a known fixed server port using e.g. an HTTP GET command or another appropriate HTTP command, reads an identification of the object to be retrieved, and then issues a request for the new object attributes, knowing the object's identification). This direct web link to the communication translator is necessary because of the missing update mechanism from web server to web client. The applet is executed on a Java Virtual Machine (JVM) at the client.

A third possibility is an implementation based on CORBA.

The present embodiment is based on RMI for notification of a client by an application.

According to the present embodiment, the graphics translation, action communication and notification are implemented as follows:

1) Graphical Elements:

The translator comprises a memory storing predefined Java graphical objects corresponding to DdiElements and vice-versa (e.g. DdiPanel ⇄java.myPanel, DdiButton⇄java.myButton, . . . ).

As a variant, the DdiElements can also be mapped on HTML objects and vice-versa.

1.1) Case where an Internet Device Controls a Home Domain Device

DDI elements are converted into HTML elements (e.g. HTML Buttons . . . ) or Java graphical elements (e.g. Java Buttons . . . ).

1.2) Case where a Home Domain Device Controls an Internet Device

The HTML elements or Java elements are converted into DDI elements.

2) Actions:

2.1) Case Where an Internet Device Controls a Home Domain Device

The user interacts with the rendered graphical elements (either the Java objects or the HTML objects). This triggers messages from the web browser to the web server residing within the translator. These messages may be HTTP messages (e.g. GET or POST), or RMI interactions (e.g. method calls) between an applet on the client side and the server. RMI interaction is achieved through an applet communicating with a Java program located at the server side, using RMI remote method calls.

The messages arriving at the server side are converted into DDI Actions, and sent on the HAVi network. The response from the DDI Target is received by the translator (acting as the DDI Controller) and is sent back to the web client, either as response to an HTTP GET message, or uses the same process as the notification.

Since not all graphical elements may be exportable through RMI, it is proposed to have the Java graphical elements that do appear generate also method calls to Java objects (located in the web server) not having a graphical representation on the pages displayed by the browser.

2.2. Case Where a home domain device controls an Internet device A DDI Action generated by the DDI Controller arrives at the translator (through its DDI Target). It is then converted either into an HTTP encapsulated message (e.g. GET or POST), or into an RMI interaction. The response sent by the web server to the web client (i.e. the translator) is then converted either into a DDI Action response, or uses the same process as the notification.

3) Notifications:

3.1) Case Where an Internet Device is Used to Control a Home Domain Device.

A notification is sent from the DDI Target to the translator (in the form of the DDI Controller) and converted into a message for the web client. This message is a RMI interaction, i.e. a remote call of a Java method of a Java applet residing in an applet on the client side). It may also be an HTTP message (a POST message in the present case) received by the applet at the client side. The HTTP POST message content may instruct the applet to request either a simple refresh of one or more graphical elements, to have a whole page downloaded, or any more or less complex update.

3.2) Case Where a Home Domain Device is Used to Control an Internet Device

The notification is sent by the web server to the web client (here the translator), which translates it into a DDI Notification message (‘NotifyDdiChange’). The notification message from the web server can be sent through RMI or using a HTTP POST message. For UPnP devices, the GENA protocol is also a possibility.

These mechanisms are implemented using RMI, as follows. First, the translation from the HAVi domain to the Internet domain will be described, and then the translation the other way round.

(I) HAVi Domain to IP Domain Translation Using RMI

1) The DdiContmller of the translator first subscribes to the HAVi-device 32, representing the DdiTarget. The subscription as such follows the rules described in the HAVi specification.

2) During the following communication, the translator fetches DDI elements (e.g. DdiButton) from the HAVi device 32, as described by the HAVi specification. It then extracts the corresponding Java objects (e.g. java.Button) from its internal database and instantiates each extracted object with the parameters of its corresponding DDI element.

3) The translator then generates an applet comprising the Java objects created by the translator. The applet is provided to an Internet client on an html-page. Several applets may be used per page, and several pages may be used.

4) The client (e.g. device 37) is now able to reference the html pages and to execute the applets, which comprise the Java (or HTML) object references to the user interface elements of the DdiTarget device (HAVi-device 32). The html pages are displayed to the user in a manner known as such. FIG. 8 illustrates this process.

According to the present embodiment, RMI is used to transmit actions from the client to the server, as illustrated by FIG. 9.

Let us suppose that a user of the Internet client 37 performs an action. For instance, the user activates a button. This action is detected by the ‘Listener’ method of the button in the applet, which then starts the RMI interaction with the server by calling a method of a remote java object. The number of methods and remote java objects is implementation dependent. The ‘Listener’ is a method of the object, which is called when the object is activated.

At the server, the action is translated to the HAVi domain (DdiAction.ACT_BUTTON), and transmitted to the controlled HAVi device by the DDI controller of the device 22. The DdiAction responds to the DDI controller, and that information is then used to change the graphical element(s) state. It is then updated at the level of the client, using RMI. The translator calls a method of a remote java object, which is in fact at the client side. This call can be more or less complex, i.e. it can simply be of the type “Refresh the whole page” or can be of the type “Change the image for this button”, or a series of such calls.

According to the present embodiment, remote method invocation is also used to implement transmission of notifications, as illustrated by FIG. 10. In the present case, a notification is sent from the controlled device (the device 32) to the controlling device (device 37), without solicitation by the device 37.

For example, a notification may be necessary if a user activates a button of the user interface of the HAVi device, if there is a status change of the device (end of tape for a VCR, for example) . . . This change, of which the translator is informed because its DDI Controller receives a NotifyDdiChange message from the DDI target device 32, must be reflected at the level of the Internet client 37.

The notification is accomplished as follows: The parameters of the NotifyDdiChange message are analysed by the translator, and a RMI interaction is performed between the translator and the applet at the web client side. The translator calls a method of a remote java object residing at the client side. The applet can then, as an example, update the look of the graphics or perform an HTTP request to refresh all or a specific part of the HTML page.

(II) Internet Domain to HAVi Domain Translation Using RMI

Control of an Internet-type device (e.g. a UPnP device 35) from the HAVi domain is made according to the process illustrated by FIG. 11.

In the case of the present embodiment, the controlled device's user interface is provided in the form of html-pages (comprising e.g. html-buttons) or applets (comprising java objects such as e.g. java.Buttons).

The translator retrieves the html pages and, based on its mapping of Java objects, respectively html objects, on DDI elements, generates appropriate DDI target data, and arranges it according to a hierarchy representing the initial data (e.g.: the translator carries out conversion of an html button or Java button to a DDI button, and arranges them appropriately for presentation to the user, in compliance with the HAVi specification).

This new DDI target becomes accessible by a DDI Controller in the HAVi domain like any other DDI Target.

We will suppose that the DDI Controller is located in the device 32. Device 32 retrieves the DDI target data and displays a corresponding user interface. In response to a user input, it sends DDI actions back to the DDI target, located in device 31. The translator of device 31 receives the DDI action and translates it into http-command(s) sent to the controlled device (e.g. an HTTP POST message on a Submit HTML button) or using RMI into a proprietary java-object-change-mechanism for the web domain

For example, when the user presses the DdiButton on the HAVi device 32, the translator converts it into an html-button ‘form’ action, which is sent to the Web device 31 with an HTTP message. The translator receives the updated data from the web server (using the connection mechanism) and is then able to update the DDI data to send the DDI action response or a DDI notification message on the home domain.

Translation of DDI graphics between the HAVi domain and Web domain is carried out as follows.

DdiElements to be translated are: DdiPanel, DdiGroup, DdiPanelLink, DdiButton, DdiBasicButton, DdiToggle, DdiAnimation, DdiShowRange, DdiSetRange, DdiEntry, DdiChoice, DdiText, DdiStatus, Ddilcon.

Note that this list may evolve as new DDI elements are specified.

The corresponding web user interface elements are dependent on the presentation of the web page: if applets are used, the appropriate java objects under Java AWT (Abstract Windows Toolkit) are e.g. java.Button, java.List, java.Label; if html is used, there are equivalent elements defined (e.g. with Forms).

The interface device comprises physical layers for accessing the transmission mediums of each network (be it two or more). It also comprises volatile and non-volatile memory for storing data and the different programs required to carry out the method that has just been described, as well as processing means such as a microprocessor or carrying out the method and for controlling the different circuits and modules of the interface device.

Although the embodiment focuses on a network comprising only two sub-networks, it is not limited to such a case.

1. Method for interfacing communication between a first device on a first network and a second device on a second network, the networks being connected by an interface device, the method being carried out by the interface device and comprising the steps of:
detecting a first message on the first network, said first message being generated by the first device, said first message being relevant for the second device;
translating the first message into a format compatible with the second device;
sending a second message to the second device on the second network, the second message informing the second device that the first message has been detected;
upon reception of a request from the second device, transmitting the translated first message.

2. Method according to claim 1, wherein the interface device further carries out the steps of
providing at least one applet, wherein said applet is adapted to receive the second message and to generate the request; and
transmitting the applet to the second device.

3. Method according to claim 2, further comprising the step of
including the at least one applet into at least one html page, and transmitting the at least one page to the second device.

4. Method according to claim 3, wherein the step of translating the first message comprises the steps of updating at least one relevant object of the html page with parameters contained in the first message.

5. Method according to claim 2, further comprising the step of:
retrieving user interface elements of the first device;
translating the user interface elements into a format compatible for control of the first device through the second device;
including the translated user interface elements into the html page.

6. Method according to claim 5, wherein the step of translating the first message comprises updating at least one translated user interface element, based on parameters comprised in the first message.

7. Method according to claim 3, wherein the html page comprises at least one java object and/or at least one html object.

8. Method according to claim 3, wherein the step of sending the second message to the second device comprises performing a remote method invocation call to the applet, the remote method of the applet being such as to trigger an appropriate request from the second device to the interface device for transmission of the translated first message.

9. Method according to claim 8, wherein the request comprises one of the following: an HTML GET message, a remote method invocation call to the interface device.

10. Method according to claim 2, wherein the applet is adapted to regularly poll a predetermined port of the interface device for determining whether a translated message is available at the interface device.

11. Method according to claim 1, wherein the request for transmission of the translated first message comprises one of the following:
a request to transmit an update of part of an html page; or
a request to transmit an update of an entire html page; or
a request to transmit an update of a java object or an HTML object.

12. Method according to claim 1, the first network is a HAVi network.

13. Method according to claim 1, wherein the second network is an Internet Protocol based network.

14. Method according to claim 1, wherein the first network is an Internet Protocol based network and the step of receiving the first message comprises receiving said message on a predetermined port from an applet in the first device.

15. Method according to claim 1, wherein the first network is an Internet Protocol based network and the step of receiving the first message comprises receiving said message through a remote method invocation call performed by an applet in the first device.

16. Device for interfacing communication between a first device on a first network and a second device on a second network, said device comprising
means for detecting a first message on the first network, said first message being generated by the first device, said first message being relevant for the second device;
means for translating the first message into a format compatible with the second device;
means for sending a second message to the second device on the second network, the second message informing the second device that the first message has been detected and upon reception of a request from the second device, transmitting the translated first message.

17. Device according to claim 16, further comprising memory for storing user interface element representations for user interface elements of devices of the first network for control by devices of the second network and vice-versa, and means for translating the user interface elements of the first device according to the representations, for transmission of the translated elements to the second device, wherein the translation means are adapted to translating actions performed on one device or notifications generated by one device to a format compatible with the other device.

18. Method for interfacing communication between a first device on a first network and a second device on a second network, the networks being connected by an interface device, the method being carried out by the interface device and comprising the steps of:
detecting a first message on the first network, said first message being generated by the first device, said first message being relevant for the second device;
translating the first message into a format compatible with the second device;
transmitting the translated message to the second device,
wherein the first and second networks are IP and HAVi networks or vice-versa, and wherein the message is a notification or an action.

19. Method according to claim 18, wherein the exchange of a notification or action between the interface device and a device on an IP based network is carried out through a remote method invocation call.

20. Method according to claim 19, wherein the transmission of a notification from the interface device to the second device on an IP based network includes having the second device regularly poll a fixed port of the interface device acting as a server.
